(19) United States
(12) Patent Application Publication
(10) Pub. No.: US 2025/0289373 A1
(43) Pub. Date: Sep. 18, 2025

(54) CONSOLE BOX

(71) Applicant: TOYODA GOSEI CO., LTD., Kiyosu-shi (JP)

(72) Inventors: Yuya SHIMIZU, Kiyosu-shi (JP); Yu HISHIDA, Kiyosu-shi (JP); Naoyuki FUKUI, Kiyosu-shi (JP); Takuto KAMAYA, Kiyosu-shi (JP); Yuya INAGAKI, Kariya-shi (JP)

(21) Appl. No.: 19/072,642

(22) Filed: Mar. 6, 2025

(30) Foreign Application Priority Data
Mar. 18, 2024 (JP) 2024-042448

(51) Int. Cl. B60R 7/04; B60N 2/75

(52) U.S. Cl. CPC B60R 7/04; B60N 2/793

(57) ABSTRACT

A console box includes a box main body, a lid, and an operation portion. The lid includes a lid main body and a pivot shaft. A lid-side restricting portion is provided on each of opposite end faces of the lid main body in the axial direction of the pivot shaft. The box main body includes two shims and two accommodating recesses. Each shim includes a supporting recess and a fitting portion. Each shim includes an engaging projection. Each accommodating recess includes an engaging groove having a step portion is formed on the inner peripheral surface. The engaging groove of each accommodating recess is configured such that, when the opening degree of the lid main body is changed to the opening side from the fully open position, the engaging projection is engaged with the step portion to restrict the movement in the axial direction of the corresponding shim.

### CROSS-REFERENCE TO RELATED APPLICATIONS

This application is based upon and claims the benefit of priority from Japanese Patent Application No. 2024-042448, filed on Mar. 18, 2024, the entire contents of which are incorporated herein by reference.

### BACKGROUND

### 1. Field

The present disclosure relates to a console box.

### 2. Description of Related Art

Japanese Laid-Open Patent Publication No. 2023-70037 discloses a console box provided in the passenger compartment of a vehicle. The console box includes a box main body having an upper opening, and a lid that is pivotally coupled to the box main body to open and close the upper opening.

The lid includes a lid main body, pivot shafts, which are each provided at one side of the lid main body in a width direction to couple the lid main body to the box main body, and operation portions, which are provided in correspondence with the pivot shafts. The operation portions are configured to move the pivot shafts inward in the width direction when the operation portions are operated.

The box main body is provided with two pairs of shims non-rotatably installed in the box main body. The shims rotatably support the opposite ends of the pivot shafts.

Each pivot shaft includes a restricting projection on each end face in the axial direction. Each shim includes an allowance recess, which receives the restricting projection of the corresponding pivot shaft. The allowance recesses allow movement of the restricting projections caused by a pivoting action of the lid main body from the fully closed position to the fully open position.

The console box is configured such that operation of each operation portion causes the corresponding pivot shaft to move inward in the width direction. This movement moves the two shims away from the pivot shaft in the axial direction, thereby decoupling the pivot shaft from the box main body.

In such a console box, when the lid main body is in the fully closed position, the lid is removed from the box main body by operating the operation portions. Further, when the lid main body is in the fully open position, each restricting projection and the side surface of the corresponding allowance recess contact each other. This restricts the opening degree of the lid main body from becoming larger than that in the fully open position.

In such a console box, when the opening degree of the lid main body is at the fully open position, a change in the opening degree to the opening side beyond the fully open position, that is, so-called excessive opening of the lid main body can cause the restricting projections to move over the side surfaces of the allowance recesses. In a such case, the two shims may move away from the pivot shaft in the axial direction without operation of the operation portion, potentially causing the lid to be detached from the box main body contrary to the intent of the occupant. Thus, there is a desire for a console box in which it is more difficult to detach the lid from the box main body in situations when excessive opening of the lid main body occurs.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a console box includes a box main body including an upper opening, a lid that is pivotally coupled to the box main body to open and close the upper opening, and an operation portion. The lid includes a lid main body and a pivot shaft provided at one side in a width direction of the lid main body. The pivot shaft couples the lid main body to the box main body. A lid-side restricting portion is provided on each of opposite end faces of the lid main body in an axial direction of the pivot shaft. The box main body includes two shims and two accommodating recesses in correspondence with opposite ends of the pivot shaft. Each shim includes a supporting recess that rotatably supports a corresponding end of the pivot shaft, and a fitting portion fitted into the corresponding lid-side restricting portion of the lid main body. The fitting portion includes a restricting surface that comes into contact with the corresponding lid-side restricting portion thereby restricting an opening degree of the lid main body from becoming larger than a fully open position. Each of the accommodating recesses accommodates the corresponding shim such that the shim is movable in the axial direction. The operation portion is configured to apply an operating force to the pivot shaft. The console box is configured such that, when the two shims move outward in the axial direction in conjunction with an operation of the operation portion, the pivot shaft is dislodged from the supporting recess, so that the pivot shaft is decoupled from the box main body. An engaging projection is formed on an outer peripheral surface of each shim. An engaging groove is formed in an inner peripheral surface of each of the accommodating recesses. The engaging groove receives the engaging projection of the corresponding shim and has a step portion configured to be engaged with the engaging projection. The engaging groove of each accommodating recess is configured such that, when the opening degree of the lid main body is changed to an opening side from the fully open position, the corresponding lid-side restricting portion presses the restricting surface to rotate the corresponding shim so that the engaging projection is engaged with the step portion to restrict movement in the axial direction of the corresponding shim.

Other features and aspects will be apparent from the following detailed description, the drawings, and the claims.

### BRIEF DESCRIPTION OF THE DRAWINGS

FIG. 1 is a perspective view showing a console box according to an embodiment.

FIG. 2 is an exploded perspective view showing a box portion, a supporting frame, shims, shim bezels, and second springs in the console box shown in FIG. 1.

FIG. 3 is an exploded perspective view showing the lid of the console box shown FIG. 1, together with operation portions.

FIG. 4 is an exploded partial perspective view of a front part of the supporting frame, a shim, a shim bezel, and a second spring shown in FIG. 2.

FIG. 5 is an exploded partial perspective view of a rear part of the supporting frame, a shim, a shim bezel, and a second spring shown in FIG. 2.

FIG. 6 is a rear view of the shim, the shim bezel, and the second spring shown in FIG. 4, when attached to the supporting frame.

FIG. 7 is a partial cross-sectional view taken along line 7-7 in FIG. 6.

FIG. 8 is an exploded partial perspective view mainly showing an operation portion shown in FIG. 3.

FIG. 9 is a longitudinal partial cross-sectional view showing an upper part of the console box shown in FIG. 1.

FIG. 10 is a partial cross-sectional view taken along line 10-10 in FIG. 9.

FIG. 11 is a partial cross-sectional view corresponding to FIG. 10, illustrating a state in which the operation portion is pressed.

FIG. 12 is a partial cross-sectional view taken along line 12-12 in FIG. 9.

FIG. 13 is a partial cross-sectional view taken along line 13-13 in FIG. 9.

FIG. 14 is a partial cross-sectional view corresponding to FIG. 7, illustrating a state in which the engaging projection is engaged with a step portion.

FIG. 15 is an exploded partial perspective view corresponding to FIG. 4, showing a console box according to a modification.

FIG. 16 is a partial cross-sectional view taken along line 16-16 in FIG. 15.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

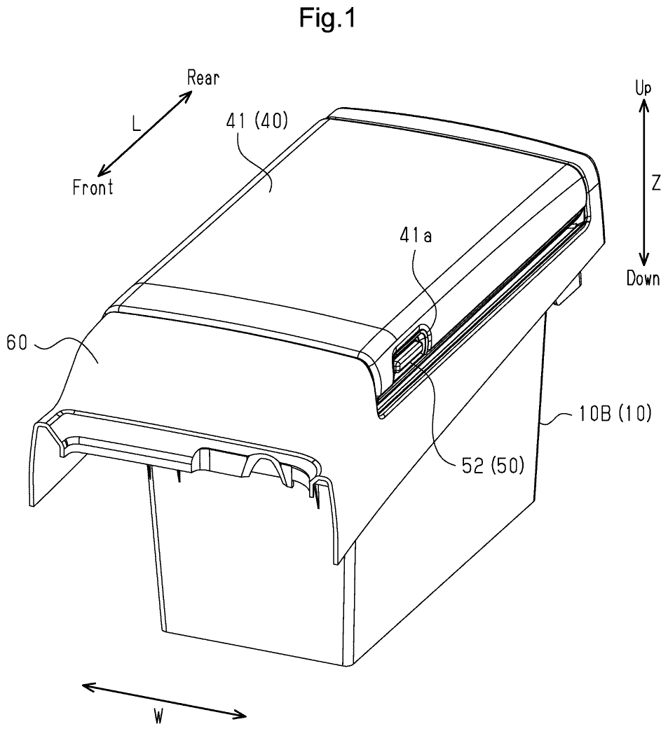

A console box according to an embodiment will now be described with reference to FIGS. 1 to 14.

In the present embodiment, the present disclosure is embodied as a console box disposed between the driver's seat and the front passenger seat in a passenger compartment.

### Basic Configuration of Console Box

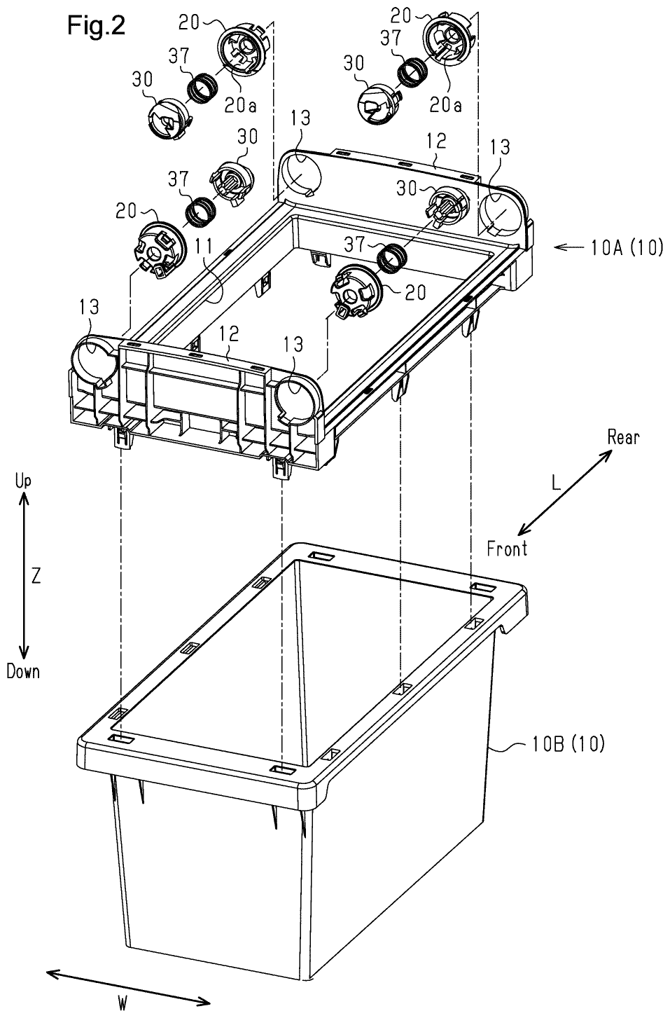

As shown in FIGS. 1 and 2, the console box includes a box main body 10, which includes an upper opening 11.

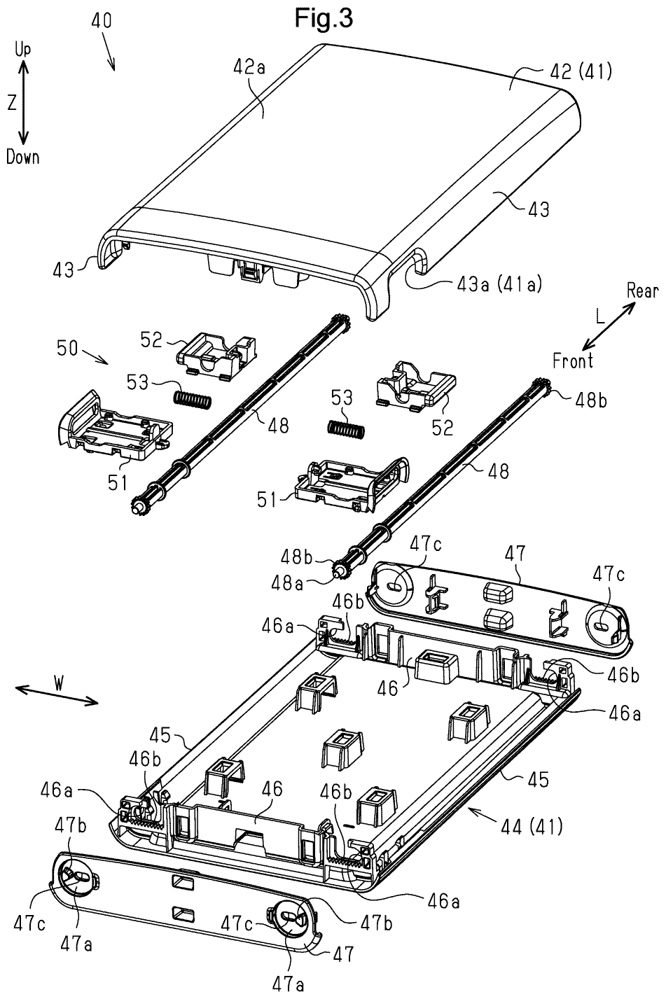

As shown in FIGS. 1 and 3, the console box includes a lid 40, which is pivotally coupled to the box main body 10 to open and close the upper opening 11.

As shown in FIGS. 2 and 3, a lid main body 41 is coupled to the box main body 10 by two sets of one pivot shaft 48 and two shims 30. The two sets are arranged to be parallel with each other at the opposite sides in a width direction of the lid main body 41 (hereinafter, referred to as a width direction W).

As shown in FIGS. 1 and 3, the lid 40 is provided with operation portions 50 that are pressed toward the center of the console box in the width direction W to apply an operating force (in the present embodiment, a pressing force toward the center) to the pivot shafts 48. The operation portions 50 are provided to correspond to the two pivot shafts 48 and are independent from each other.

The lid 40 is configured such that the lid main body 41 is pivotable with respect to the box main body 10 about the axis of one pivot shaft 48 selected from the two pivot shafts 48. The lid 40 is also configured to be removed from the box main body 10 when both operation portions 50 are simultaneously operated to decouple the pivot shafts 48 from the box main body 10.

As shown in FIG. 1, the console box includes a housing 60 that accommodates the box main body 10 in a state in which the lid 40 is exposed to one side (upper side in the vertical direction in FIG. 1) in a height direction (hereinafter, referred to as a height direction Z) of the console box.

In the present embodiment, the one side in the height direction Z corresponds to the upper side in the up-down direction of the vehicle when the vehicle is positioned on a horizontal plane. Therefore, in the following description, one side in the height direction Z is referred to as an “upper side”, and the other side in the height direction Z is referred to as a “lower side”. In the present embodiment, the box main body 10 is accommodated in the housing 60 such that an axial direction (hereinafter, referred to as an axial direction L) extending along the axes of the pivot shafts 48 and the width direction W agree with the front-rear direction of the vehicle and the vehicle width direction, respectively. Therefore, in the following description, the side corresponding to the front side in the front-rear direction in the axial direction L may be simply referred to as a “front side”, and the side corresponding to the rear side in the front-rear direction may be simply referred to as a “rear side”.

In the following description, the side farther from the center of the console box in each of the axial direction L and the width direction W will simply be referred to as an “outer side”, and a side closer to the center will simply be referred to as an “inner side”. In addition, a position at which the lid main body 41 closes the upper opening 11 of the box main body 10 will be referred to as a “fully closed position”, and the side toward which the lid main body 41 is opened from the fully closed position in the circumferential direction R around the axis of the pivot shaft 48 will simply be referred to as an “opening side”.

Each component of the console box will now be described.

### Box Main Body 10

As shown in FIG. 2, the box main body 10 is made of a hard plastic to have a substantially rectangular parallelepiped shape.

The upper opening 11 has a rectangular shape in plan view, having a pair of long sides extending in the axial direction L and a pair of short sides extending in the width direction W.

The box main body 10 has a symmetrical structure with respect to the axial direction L and a symmetrical structure with respect to the width direction W.

The box main body 10 includes a supporting frame 10A and a box portion 10B, which is formed separately from the supporting frame 10A.

The supporting frame 10A has the upper opening 11 of the box main body 10 and front and rear supporting portions 12, and forms an upper part of the box main body 10.

The box portion 10B has an accommodation space therein and forms a lower portion of the box main body 10.

The supporting frame 10A is attached to an upper part of the box portion 10B by a snap-fit structure.

As shown in FIG. 2, each of the two supporting portions 12 includes two mounting hole portions 13 formed through the supporting portion 12 in the axial direction L at the opposite sides in the width direction W. Each mounting hole portion 13 has the shape of a cylinder.

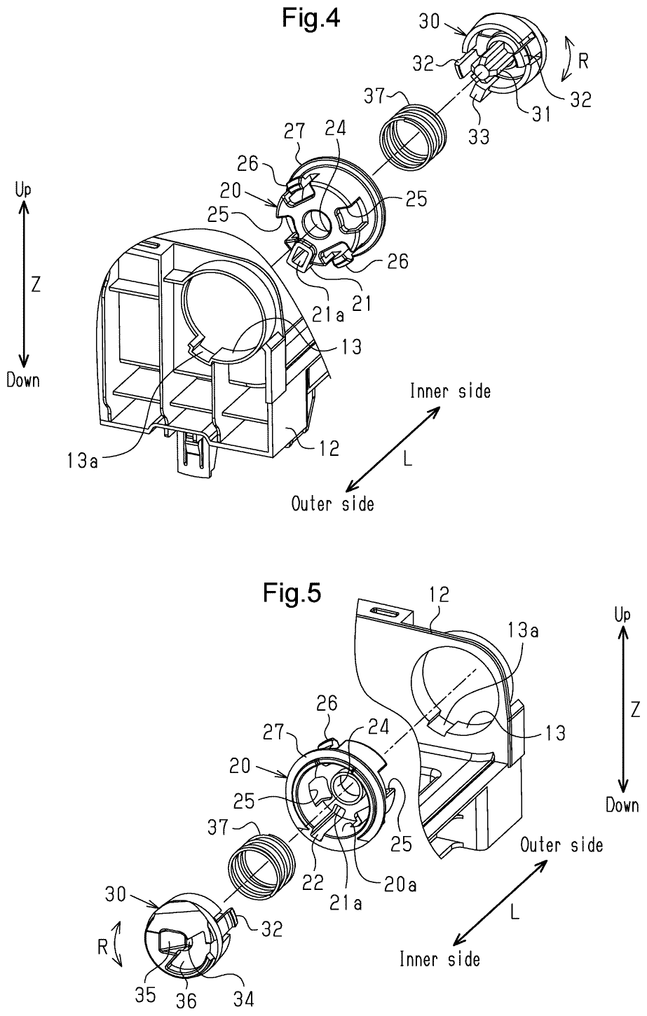

As shown in FIGS. 4 and 5, each mounting hole portion 13 includes a restriction groove 13a. The restriction groove 13a is provided in the inner peripheral surface of the mounting hole portion 13 and extends in the axial direction L.

### Shim Bezels 20

As shown in FIG. 2, a shim bezel 20 made of a hard plastic is attached to each of the mounting hole portions 13.

Each shim bezel 20 has the shape of a cylinder with a bottom and an accommodating recess 20a, which accommodates a shim 30, which will be discussed below. Each shim bezel 20 is attached to the corresponding mounting hole portion 13 with the opening of the shim bezel 20 facing inward in the axial direction L.

As shown in FIGS. 4 and 5, each shim bezel 20 is provided with a restricting protrusion 21, an engaging groove 22, an insertion hole 24, two engaging holes 25, two engaging tabs 26, and a flange 27.

The restricting protrusion 21 is provided on the outer surface of the shim bezel 20 to extend in an L-shape from the bottom to the peripheral wall. The restricting protrusion 21 includes a hole 21a extending in the axial direction L. The restricting protrusion 21 is fitted into the restriction groove 13a so as not to be rotatable in the circumferential direction R. Thus, the shim bezel 20 is attached to the mounting hole portion 13 so as not to be rotatable in the circumferential direction R (refer to FIG. 7).

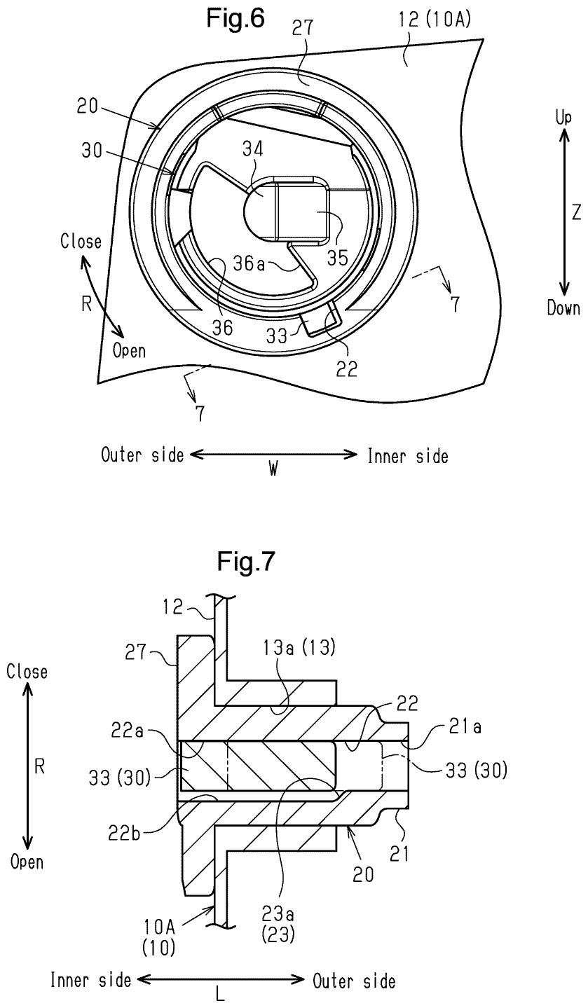

The engaging groove 22 is provided in the inner peripheral surface of the shim bezel 20 and extends in the axial direction L. The engaging groove 22 is formed at a position overlapping with the restricting protrusion 21 in the radial direction of the shim bezel 20, and is continuous with the hole 21a in the axial direction L. An engaging projection 33 of the shim 30, which will be discussed below, is fitted into the engaging groove 22 (refer to FIGS. 6 and 7).

The insertion hole 24 extends through the center of the bottom portion of the shim bezel 20 in the axial direction L.

The two engaging holes 25 are located at the opposite sides of the insertion hole 24 and extend from the bottom of the shim bezel 20 to the peripheral wall of the shim bezel 20. The two engaging holes 25 are located at the opposite sides of the insertion hole 24 in the width direction W.

The two engaging tabs 26 protrude outward in the axial direction L from the peripheral wall of the shim bezel 20. The two engaging tabs 26 are provided at the opposite sides of the insertion hole 24. In the present embodiment, the engaging holes 25 and the engaging tabs 26 are alternately arranged at intervals in the circumferential direction R. The two engaging tabs 26 are engaged with an outer opening edge of the mounting hole portion 13 in the axial direction L.

The flange 27 extends radially outward from the opening of the shim bezel 20. The flange 27 is in contact with an inner opening edge of the mounting hole portion 13 in the axial direction L (refer to FIG. 7).

The shim bezel 20 is attached to the mounting hole portion 13 so as not to be movable in the axial direction L by sandwiching the mounting hole portion 13 between the two engaging tabs 26 and the flange 27 from the front and the rear.

As shown in FIG. 7, the engaging groove 22 includes a step portion 23 forming a step in the axial direction L. The engaging groove 22 includes two side surfaces 22a, 22b, and the step portion 23 is formed on the side surface 22a located on the opening side in the circumferential direction R. The step portion 23 includes an engaging surface 23a that is engageable with the engaging projection 33. The engaging surface 23a is inclined so as to prevent engagement between the engaging projection 33 and the step portion 23 when the lid main body 41 is in the fully closed position. In the present embodiment, the engaging surface 23a is inclined so as to be closer to the side surface 22a as the engaging surface 23a extends toward the outside in the axial direction L.

### Lid 40

As shown in FIG. 3, the lid 40 includes the lid main body 41 and the two pivot shafts 48.

Hereinafter, the lid 40 in a state in which the lid main body 41 is at the fully closed position will be described.

The lid main body 41 has a rectangular shape in plan view, having a pair of long sides extending in the axial direction L and a pair of short sides extending in the width direction W.

The lid main body 41 has a symmetrical structure with respect to the axial direction L and a symmetrical structure with respect to the width direction W.

The lid main body 41 includes a first half body 42, a second half body 44, and two end plates 47.

The first half body 42 has a first surface 42a of the lid main body 41. The first surface 42a includes an armrest surface. In the present embodiment, the entire first surface 42a forms an armrest surface.

The first half body 42 includes two side walls 43 extending in the axial direction L on the opposite sides in the width direction W. Each side wall 43 includes a cutout 43a in a front part.

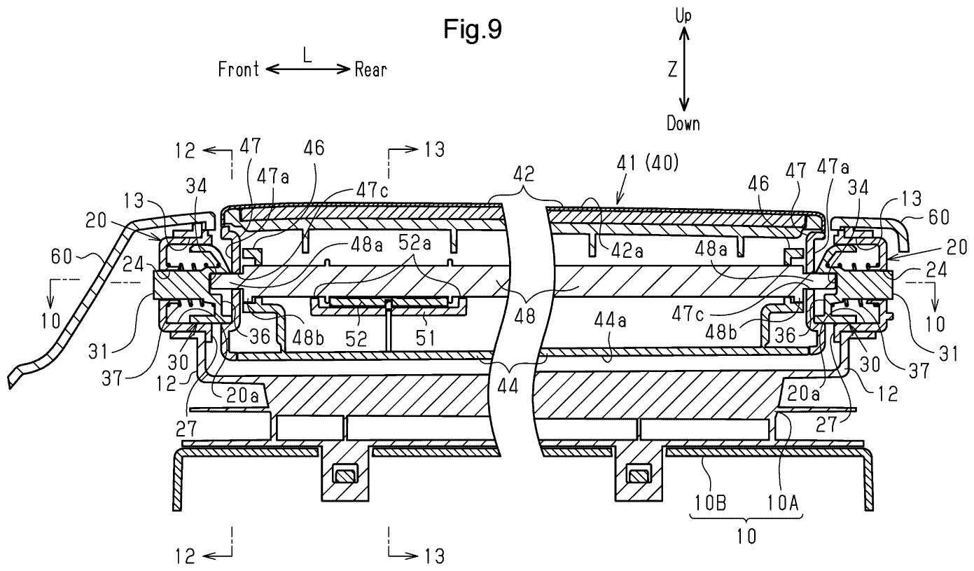

As shown in FIG. 9, the second half body 44 includes a second surface 44a, which is located on the back side of the first surface 42a in the lid main body 41. The second surface 44a includes a tray surface with a recess, for example (refer to FIG. 13).

The box main body 10 and the lid 40 have shapes that allow the lid 40 to be attached to the box main body 10 regardless of which of the first surface 42a and the second surface 44a is facing upward.

As shown in FIG. 3, the second half body 44 includes two side walls 45 extending in the axial direction L on the opposite sides in the width direction W. An operation hole 41a is formed by the cutout 43a and the upper edge of the side wall 45 (refer to FIG. 13).

The second half body 44 includes two inner walls 46 extending in the width direction W on the opposite sides in the axial direction L. Each inner wall 46 includes two cutouts 46a and two racks 46b extending in the width direction W at the opposite sides in the width direction W.

A pivot shaft 48, which will be discussed below, is inserted into the cutout 46a, and the pivot shaft 48 is allowed to move in the width direction W.

The rack 46b is located outward of the cutout 46a in the axial direction L.

The two end plates 47 are respectively attached to the two inner walls 46 of the second half body 44, and respectively form the front and rear end faces of the lid main body 41. In other words, the two end plates 47 form the opposite end faces in the axial direction L of the lid main body 41.

Each end plate 47 includes two recesses 47a formed in the outer surface of the end plate 47 at the opposite sides in the width direction W. Each recess 47a has a pivot hole 47c in the bottom. The pivot hole 47c extends through the end plate 47 in the axial direction L and is elongated in the width direction W. The pivot hole 47c extends inward in the width direction W from the center of the recess 47a. The pivot holes 47c receive pin portions 48a of the pivot shafts 48, which will be discussed below.

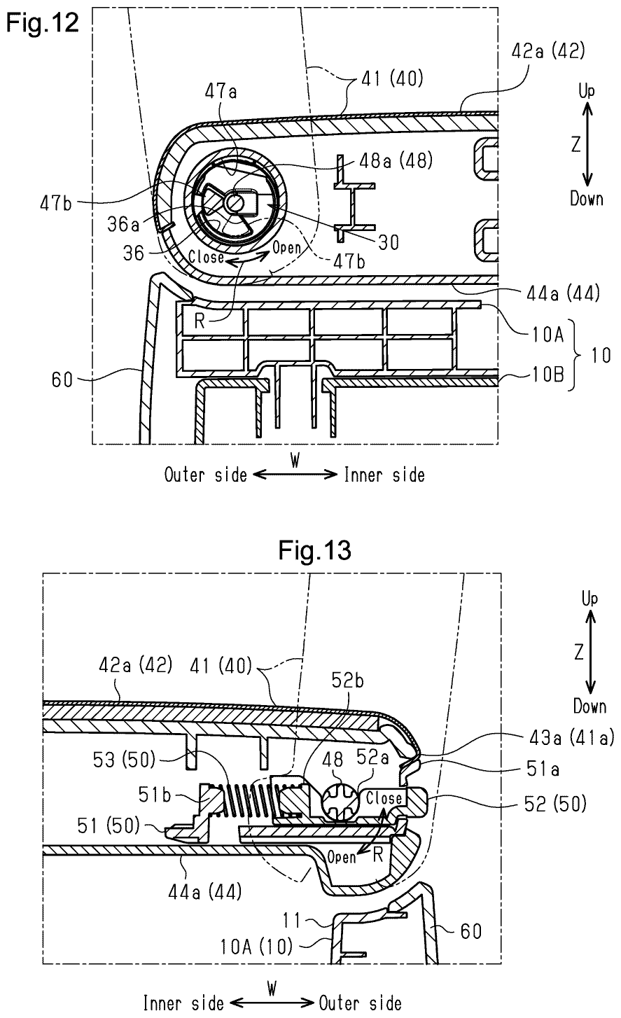

A protrusion 47b, which is a lid-side restricting portion, is provided on the bottom surface of each recess 47a. The protrusion 47b is provided adjacent to the outer side of the pivot hole 47c in the width direction W. The protrusion 47b is fitted into an allowance recess 36 of the shim 30, which will be discussed below (refer to FIG. 12).

Each pivot shaft 48 includes two pin portions 48a and two pinions 48b.

The pin portions 48a form the ends of the pivot shaft 48.

The pinions 48b are located on the inner sides in the axial direction L of the pin portions 48a at the opposite ends of the pivot shaft 48. The pinions 48b mesh with the racks 46b and are supported by the racks 46b so as to be rotatable and movable in the width direction W.

### Operation Portions 50

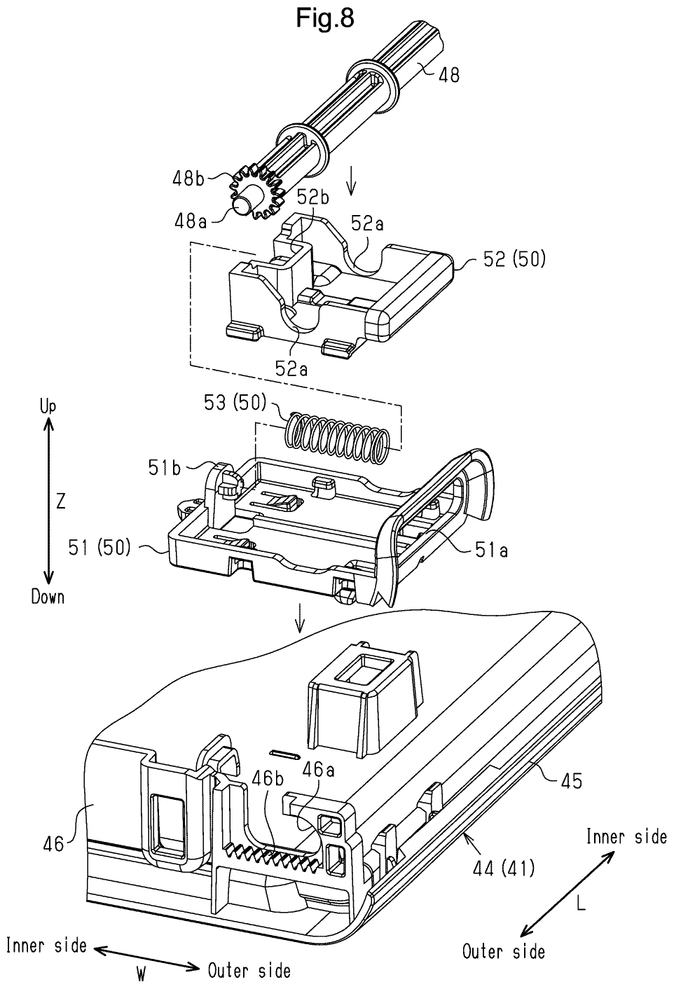

As shown in FIGS. 3 and 8, the operation portions 50 include two bases 51, two operation portion main bodies 52, and two first springs 53.

The two bases 51 are arranged alongside each other in the width direction W on the second half body 44. The bases 51 are fixed to the upper surface of the second half body 44.

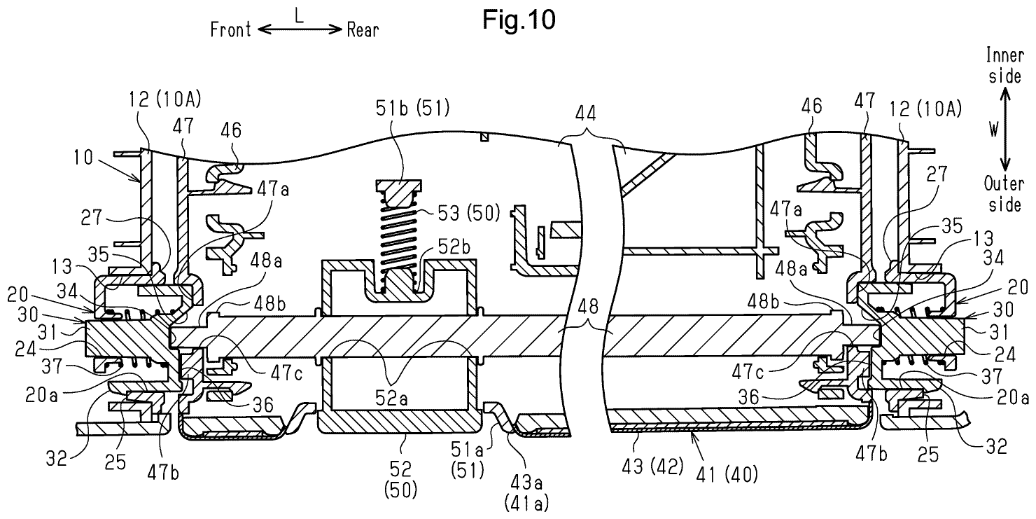

As shown in FIGS. 8 and 10, each base 51 includes a gate portion 51a at an outer portion in the width direction W. The gate portion 51a is exposed to the outside of the lid 40 through the operation hole 41a. The base 51 includes a spring receiving portion 51b provided on the upper surface. The spring receiving portion 51b is provided in an inner portion of the base 51 in the width direction W.

On each base 51, the operation portion main body 52 is provided so as to be movable in the width direction W through the gate portion 51a.

The operation portion main body 52 includes two shaft receiving portions 52a at the opposite ends in the axial direction L. The shaft receiving portions 52a each have an arcuate shape opening upward. The shaft receiving portions 52a pivotally support the pivot shaft 48.

Each operation portion main body 52 includes a spring receiving portion 52b. The spring receiving portion 52b is provided outward of the spring receiving portion 51b in the width direction W.

A first spring 53 is provided between the spring receiving portion 51b and the spring receiving portion 52b. The first spring 53 constantly urges the operation portion main body 52 outward in the width direction W (refer to FIGS. 10 and 13).

### Shims 30

As shown in FIGS. 2, 4, and 5, the shims 30 each have the shape of a cylinder with a bottom, and are respectively accommodated in the accommodating recesses 20a of the four shim bezels 20. The shims 30 are each accommodated in the corresponding accommodating recess 20a in an orientation in which the opening is directed outward in the axial direction L.

As shown in FIGS. 4 and 5, each shim 30 includes a shaft portion 31, two engaging tabs 32, an engaging projection 33, a supporting recess 34, an inner inclined surface 35, and an allowance recess 36.

The shaft portion 31 projects toward the bottom surface of the accommodating recess 20a and extends in the axial direction L. The shaft portion 31 is inserted into the insertion hole 24 so as to be movable in the axial direction L.

A second spring 37 is accommodated between the bottom surface of the accommodating recess 20a and the bottom surface of the shim 30 with the shaft portion 31 inserted into the second spring 37. The second spring 37 always urges the shim 30 inward in the axial direction L.

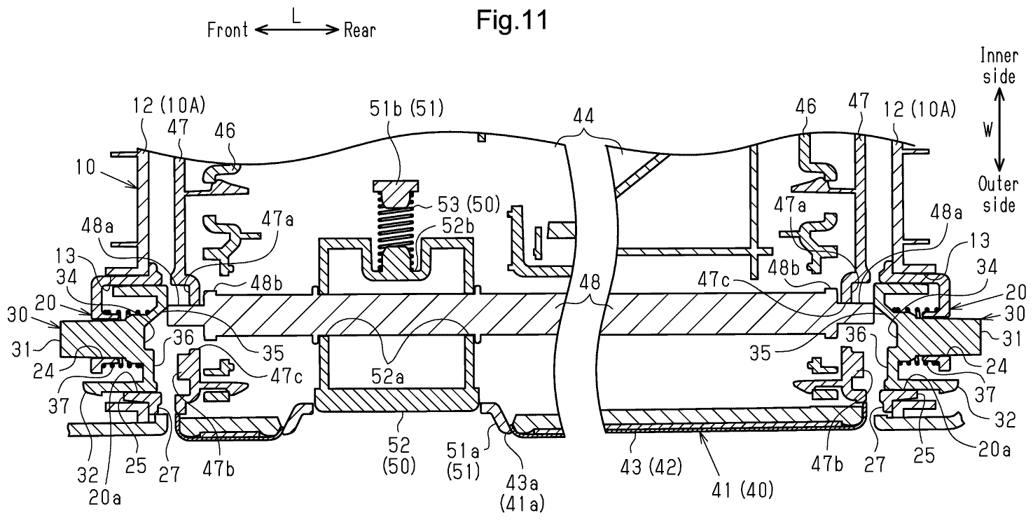

The two engaging tabs 32 protrude from the peripheral wall of the shim 30 toward the bottom surface of the accommodating recess 20a and extend in the axial direction L. The two engaging tabs 32 are respectively engaged with the edges of the two engaging holes 25 (refer to FIG. 10). The two engaging tabs 32 are inserted into the two engaging holes 25 so as to be movable in the axial direction L (refer to FIG. 11).

The engaging projection 33 projects from the outer peripheral surface of the shim 30 and extends in the axial direction L. The engaging projection 33 is fitted into the engaging groove 22 so as to be movable in the axial direction L and pivotable in the circumferential direction R (refer to FIG. 7).

The shim 30 is configured to be movable in the axial direction L between a position at which the engaging tabs 32 are engaged with the edges of the engaging holes 25 (refer to FIG. 10) and a position at which the engaging tabs 32 are separated from the edges (refer to FIG. 11).

As shown in FIGS. 5 and 6, the supporting recess 34 and the allowance recess 36 open inward in the axial direction L on the surface of the shim 30 opposite to the surface on which the shaft portion 31 is provided.

The bottom surface of the supporting recess 34 is located at the center of the shim 30. The supporting recess 34 rotatably supports the corresponding pin portion 48a of the pivot shaft 48.

The inner inclined surface 35 is provided on a side surface of the supporting recess 34 at an inner portion in the width direction W. The inner inclined surface 35 is inclined inward in the axial direction L as the inner inclined surface 35 extends inward in the width direction W (refer to FIG. 10). The inner inclined surface 35 is provided at a position overlapping with the pin portion 48a of the pivot shaft 48 in the width direction W (refer to FIG. 11).

The allowance recess 36 is configured to allow movement of the protrusion 47b caused by rotation of the lid main body 41, and extends arcuately around the axis of the shim 30. A portion of the side surface of the allowance recess 36 positioned on the opening side in the circumferential direction R is provided with a restricting surface 36a, which comes into contact with the protrusion 47b to restrict the opening degree of the lid main body 41 from moving to the opening side beyond the fully open position (refer to FIG. 12). The allowance recess 36 corresponds to a fitting portion according to the present disclosure.

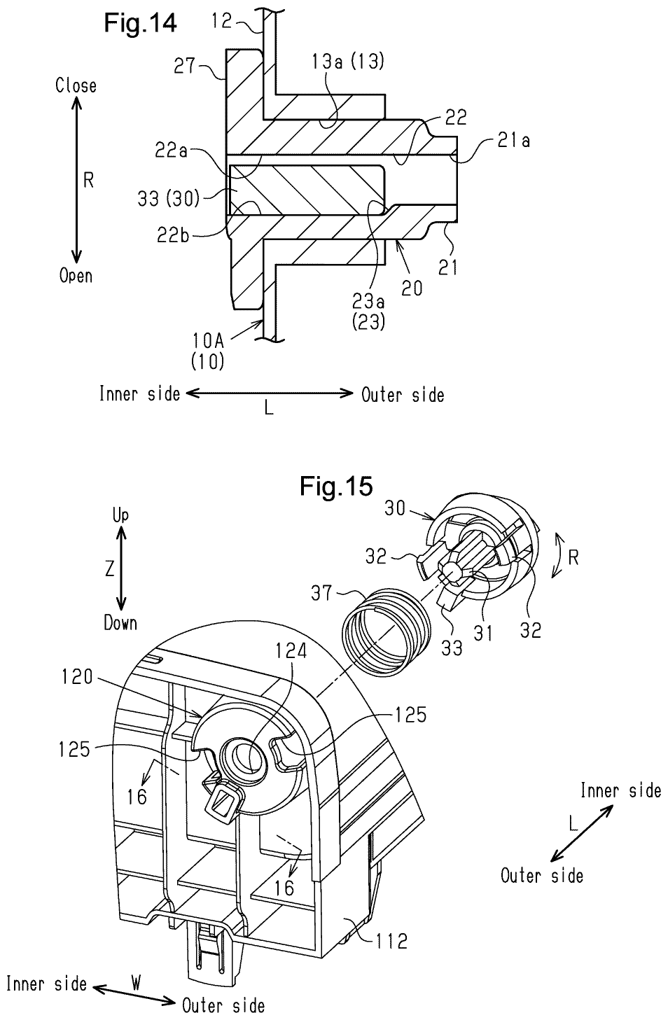

As shown in FIG. 14, the console box of the present embodiment is configured such that, when the opening degree of the lid main body 41 changes to the opening side from the fully open position, the restricting surface 36a is pressed by the protrusion 47b so that the shim 30 rotates to the opening side in relation to the shim bezel 20. This causes the engaging projection 33 to be engaged with the engaging surface 23a of the step portion 23 to restrict movement of the shim 30 in the axial direction L.

### Operation of the Present Embodiment

Operation of the present embodiment will now be described.

As shown in FIGS. 10 and 11, when the lid main body 41 is in the fully closed position, if the operation portion 50 is pressed inward in the width direction W, the inner inclined surface 35 of the supporting recess 34 of the shim 30 is pressed inward in the width direction W by the pin portion 48a of the pivot shaft 48. At this time, since the inner inclined surface 35 is inclined inward in the axial direction L as it extends inward in the width direction W, the shim 30 moves outward in the axial direction L against the urging force of the second spring 37. Then, when the pin portion 48a of the pivot shaft 48 is dislodged from the supporting recess 34 of the shim 30, the pivot shaft 48 and the box main body 10 are decoupled from each other.

In this manner, when one of the two operation portions 50 is pushed inward, the box main body 10 and the pivot shaft 48 that corresponds to that operation portion 50 are decoupled from each other. This allows the lid main body 41 to pivot about the pivot shaft 48 of the other operation portion 50 (Operation 1).

Subsequently, as shown in FIG. 12, when the lid main body 41 is rotated from the fully closed position toward the opening side in the circumferential direction R, the protrusion 47b moves in the allowance recess 36 toward the opening side in the circumferential direction R. The restricting surface 36a is provided in the allowance recess 36. Contact between the protrusion 47b and the restricting surface 36a restricts the opening degree of the lid main body 41 from increasing beyond the fully open position of the lid main body 41 indicated by the long-dash double-short-dash lines in FIG. 12 (Operation 2).

When the opening degree of the lid main body 41 is at the fully open position, the opening degree may change to the opening side in the circumferential direction R from the fully open position. This is referred to as excessive opening of the lid main body 41. When such excessive opening occurs, first, the restricting surface 36a of the allowance recess 36 is pressed by the protrusion 47b, so that the shim 30 rotates to the opening side in the circumferential direction R in relation to the shim bezel 20 (refer to FIG. 14). At this time, as the shim 30 rotates, the engaging projection 33 moves in the engaging groove 22 to a position at which the engaging projection 33 contacts the side surface 22b. The step portion 23, having the engaging surface 23a, is provided on the side surface 22b of the engaging groove 22. Therefore, as the protrusion 47b engages with and moves over the restricting surface 36a in the axial direction L in conjunction with the excessive opening, the outward movement of the shim 30 in the axial direction L is restricted by the engaging projection 33 engaging with the engaging surface 23a of the step portion 23. Accordingly, the pivot shaft 48 and the box main body 10 are prevented from being decoupled from each other without operation of the operation portion 50 (Operation 3).

When the lid main body 41 is in the fully closed position, if both operation portions 50 are pressed simultaneously, both pivot shafts 48 are decoupled from the box main body 10. This allows the lid 40 to be detached from the box main body 10 (Operation 4).

### Advantages of the Present Embodiment

The present embodiment has the following advantages.

(1) The lid 40 includes the lid main body 41 and the two pivot shafts 48. The box main body 10 includes two pairs of shims 30 and two pairs of shim bezels 20. Specifically, one of the two shims 30 and one of the two shim bezels 20 are provided at each of the opposite ends each pivot shaft 48. Each shim 30 includes the supporting recess 34 and the allowance recess 36. Each shim bezel 20 includes the accommodating recess 20a. The engaging projection 33 is formed on the outer peripheral surface of each shim 30. The engaging groove 22 is formed in the inner peripheral surface of each shim bezel 20. The engaging groove 22 receives the engaging projection 33 of the corresponding shim 30 and has the step portion 23 configured to be engaged with the engaging projection 33. The engaging groove 22 of each accommodating recess 20a is configured such that, when the opening degree of the lid main body 41 changes to the opening side from the fully open position, the restricting surface 36a is pressed by the corresponding protrusion 47b so that the corresponding shim 30 rotates to the opening side in the circumferential direction R. This causes the engaging projection 33 to be engaged with the step portion 23 to restrict movement of the shim 30 in the axial direction L.

This configuration achieves Operations 1 to 3 of the present embodiment. Therefore, in a situation in which the lid main body 41 is opened excessively, the lid 40 is prevented from being removed from the box main body 10.

(2) The step portion 23 includes the engaging surface 23a that is engageable with the engaging projection 33. The engaging surface 23a is inclined so as to prevent engagement between the engaging projection 33 and the step portion 23 when the lid main body 41 is in the fully closed position.

When there are dimensional variations in the shims 30 and/or the shim bezels 20, the engaging projection 33 may engage with the step portion 23 as the shims 30 move outward in the axial direction L during the pressing operation of the operation portion 50, even if the lid main body 41 is in the fully closed position. In this case, it may be difficult to detach the lid 40 from the box main body 10.

In this regard, according to the above-described configuration, the engaging surface 23a of the step portion 23 is inclined so as to suppress engagement between the engaging projection 33 and the step portion 23 when the lid main body 41 is in the fully closed position. Therefore, even in a case in which there are dimensional variations in the shims 30 and/or the shim bezels 20, the engaging surface 23a hinders engagement between the engaging projection 33 and the step portion 23 when the lid main body 41 is at the fully closed position. Thus, when the lid main body 41 is located at the fully closed position, the lid 40 can be readily removed from the box main body 10.

(3) The box main body 10 is made of a hard plastic. The console box includes the shim bezels 20, which are made of a hard plastic and formed separately from the box main body 10. Each of the shim bezels 20 has the accommodating recess 20a. The shim bezels 20 are attached to the box main body 10 in a non-rotatable manner.

The accommodating recess 20a, which includes the engaging groove 22, requires high dimensional accuracy. If the box main body 10 is provided with accommodating recesses, the box main body 10 itself must also meet stringent dimensional accuracy requirements. This increases the difficulty of molding the box main body 10.

In this regard, according to the above-described configuration, an accommodating recess with the engaging groove 22 is provided in each shim bezel 20, which is smaller in size than the box main body 10. This structure facilitates the molding of the box main body 10.

### Modifications

The above-described embodiment may be modified as follows. The above-described embodiment and the following modifications can be combined as long as the combined modifications remain technically consistent with each other.

The recess of the second surface 44a of the lid main body 41 may be omitted. That is, both the first surface 42a and the second surface 44a may be configured without any recesses. In this case, for example, the first surface 42a and the second surface 44a may have different designs.

In the above-described embodiment, the lid main body 41 may have a shape that prevents it from being mounted to the box main body 10 when the second surface 44a is oriented upward.

In the above-described embodiment, the box main body 10 made of a hard plastic is illustrated as an example, considering moldability and durability. However, any material may be used to form the box main body 10, as long as such a modification falls within the scope of achieving the operational advantages of the above-described embodiment.

In the above-described embodiment, the shim bezels 20 made of a hard plastic are illustrated as an example, considering moldability and durability. However, any material may be used to form the shim bezels 20, as long as such a modification falls within the scope of achieving the operational advantages of the above-described embodiment.

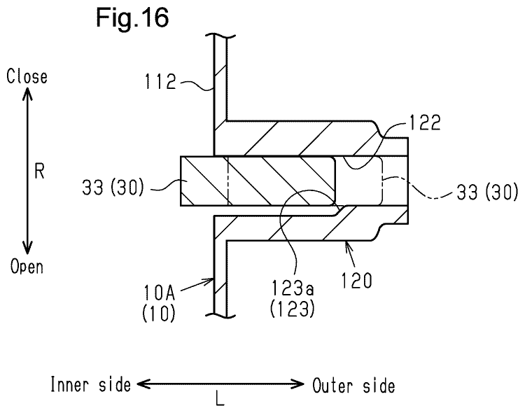

The accommodating recess according to the present disclosure is not limited to the one formed by the shim bezel 20 provided separately from the box main body 10, and may be provided integrally with the box main body 10. In such a case, the box main body 10 may be constructed, for example, as follows. In the following description, reference numerals 1**, which are obtained by adding 100 to the reference numerals ** in the above-described embodiment, are given to components that correspond to the components in the above-described embodiment, and redundant explanations are omitted. As shown in FIGS. 15 and 16, each of two supporting portions 112 is provided with an accommodating recess 120 formed integrally with the supporting portion 112, in place of the mounting hole portion 13. The accommodating recess 120 includes an engaging groove 122, an insertion hole 124, and two engaging holes 125. The engaging groove 122 is provided with a step portion 123 having an engaging surface 123a.

This configuration achieves similar operations as Operations 1 to 4 of the above-described embodiment. Further, according to the above-described configuration, the number of components of the console box is reduced as compared with a case in which the shim bezels 20 that form the accommodating recesses are provided.

The step portion 23 is not limited to the one having the engaging surface 23a inclined so as to be closer to the side surface 22a as it extends outward in the axial direction L as illustrated in the above-described embodiment. The engaging surface of the step portion 23 may be, for example, a surface extending orthogonally to the axial direction L.

In the above-described embodiment, the configuration is illustrated in which the protrusion 47b is provided on the lid main body 41 and the allowance recess 36 is provided in the shim 30. However, alternatively, the protrusion may be provided on the shim 30, and an arcuate allowable recess may be provided in the recess 47a of the lid main body 41. In this case, the protrusion may be provided below the supporting recess 34 in the height direction Z. Furthermore, the surface of the protrusion on the side in the circumferential direction R that corresponds to the closing side of the lid main body 41 may serve as the restricting surface that contacts the side surface of the allowance recess. The protrusion corresponds to a fitting portion according to the present disclosure, and the allowance recess corresponds to a lid-side restricting portion according to the present disclosure.

In the above-described embodiment, the operation portions 50 are configured to be pressed inward in the width direction W. However, the operation portions are not limited to this configuration and may instead be a lever-type structure capable of tilting. Further, the operation portions 50 are not limited to be provided in the lid 40, and may be provided in the box main body 10 or the housing 60. In these cases, a conversion mechanism may be provided that converts an operating force for tilting the operation portions into a force for moving the pivot shafts 48 inward in the width direction W.

In the above-described embodiment, the two pivot shafts 48 are provided to be parallel with each other at the opposite sides in the width direction W. In place of this, two pivot shafts may be provided to be parallel with each other at the opposite sides in the axial direction L. In this case, the width direction of the lid main body agrees with the front-rear direction of the vehicle, and the axial direction of the pivot shafts agrees with the vehicle width direction.

In the above-described embodiment, one of the two pivot shafts 48 may be omitted. That is, the pivot shaft 48 may be provided only at one side in the width direction of the lid main body 41.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A console box, comprising:
a box main body including an upper opening;
a lid that is pivotally coupled to the box main body to open and close the upper opening; and
an operation portion, wherein
the lid includes:
a lid main body; and
a pivot shaft provided at one side in a width direction of the lid main body, the pivot shaft coupling the lid main body to the box main body,
a lid-side restricting portion is provided on each of opposite end faces of the lid main body in an axial direction of the pivot shaft,
the box main body includes two shims and two accommodating recesses in correspondence with opposite ends of the pivot shaft,
each shim includes:
a supporting recess that rotatably supports a corresponding end of the pivot shaft; and
a fitting portion fitted into the corresponding lid-side restricting portion of the lid main body, the fitting portion including a restricting surface that comes into contact with the corresponding lid-side restricting portion thereby restricting an opening degree of the lid main body from becoming larger than a fully open position,
each of the accommodating recesses accommodates the corresponding shim such that the shim is movable in the axial direction,
the operation portion is configured to apply an operating force to the pivot shaft,
the console box is configured such that, when the two shims move outward in the axial direction in conjunction with an operation of the operation portion, the pivot shaft is dislodged from the supporting recess, so that the pivot shaft is decoupled from the box main body,
an engaging projection is formed on an outer peripheral surface of each shim, and
an engaging groove is formed in an inner peripheral surface of each of the accommodating recesses, the engaging groove receiving the engaging projection of the corresponding shim and having a step portion configured to be engaged with the engaging projection, and
the engaging groove of each accommodating recess is configured such that, when the opening degree of the lid main body is changed to an opening side from the fully open position, the corresponding lid-side restricting portion presses the restricting surface to rotate the corresponding shim so that the engaging projection is engaged with the step portion to restrict movement in the axial direction of the corresponding shim.

2. The console box according to claim 1, wherein the step portion includes an engaging surface that is engageable with the engaging projection, the engaging surface being inclined so as to prevent engagement between the engaging projection and the step portion when the lid main body is in a fully closed position.

3. The console box according to claim 1, wherein
the box main body is made of a plastic,
the console box further comprises two plastic shim bezels formed separately from the box main body, each of the two plastic shim bezels having one of the accommodating recesses, and
the shim bezels are attached to the box main body in a non-rotatable manner.
